(19) United States
(12) Patent Application Publication
(10) Pub. No.: US 2026/0304502 A1
(43) Pub. Date: Oct. 1, 2026

(54) EVOLVED SESSIONS MANAGEMENT FOR FUTURE-GENERATION NETWORKS

(71) Applicant: InterDigital Patent Holdings, Inc., Wilmington, DE (US)

(72) Inventors: Anuj SETHI, Ottawa (CA); Samir FERDI, Kirkland (CA); Jung Je SON, Warrington, PA (US); Guanzhou WANG, Brossard (CA); Taimoor ABBAS, Sainte-Julie (CA)

(73) Assignee: InterDigital Patent Holdings, Inc., Wilmington, DE (US)

(21) Appl. No.: 19/092,892

(22) Filed: Mar. 27, 2025

(51) Int. Cl. H04W 76/10; H04W 8/22; H04W 12/0431; H04W 48/18

(52) U.S. Cl. CPC H04W 76/10; H04W 8/22; H04W 12/0431; H04W 48/18

(57) ABSTRACT

As described herein there are one or more methods, systems, and/or device for managing packet data unit (PDU) sessions between a wireless transmit receive unit and a network (e.g., a node of the network, such as a base station). The network may have service based interfaces.

### BACKGROUND

A Protocol Data Unit (PDU) session is a mechanism used in communication networks to establish end-to-end user plane connectivity between a wireless device and a specific Data Network (DN). There is a need to address how a PDU session may be managed in future communication systems where increased demands are made on the system due to advancements in technology and performance objectives.

### SUMMARY

As described herein there are one or more methods, systems, and/or device for managing packet data unit (PDU) sessions between a wireless transmit receive unit and a network (e.g., a node of the network, such as a base station). The network may have service based interfaces.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a 5G system architecture.

FIG. 3 illustrates an example of a control plane stack between a WTRU and an AMF.

FIG. 4 illustrates an example of Next Gen Network Architecture as SBI gateway.

FIGS. 5a and 5b illustrates an example of a PDU establishment procedure.

FIG. 6 illustrates an example of a key hierarchy generation in 6GS with 6GSM as a security anchor.

FIG. 7 illustrates an example of a PDU session modification procedure.

FIG. 8 illustrates an example of a PDU session release procedure.

FIG. 9 illustrates an example flow diagram.

### DETAILED DESCRIPTION

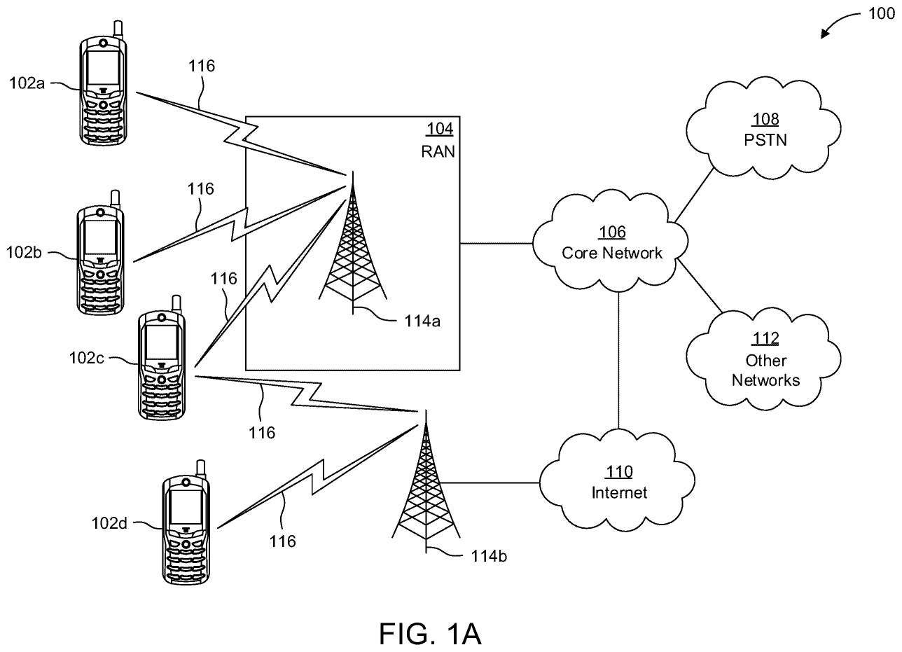

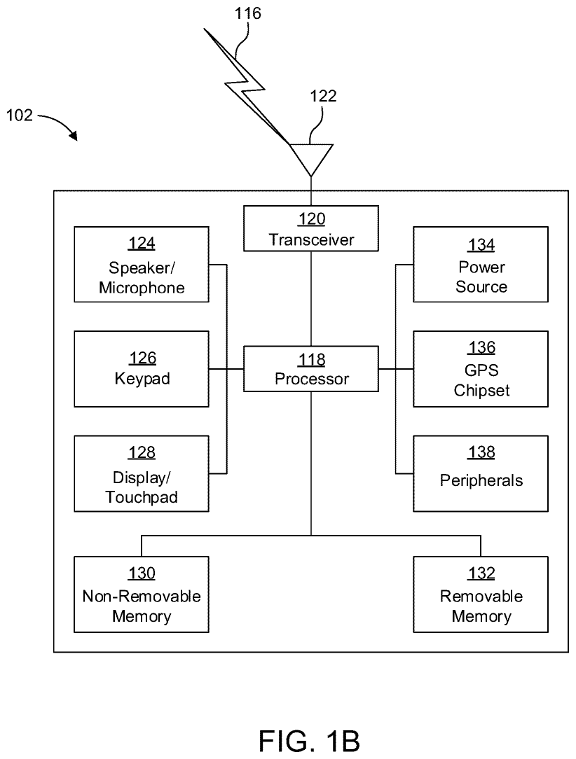

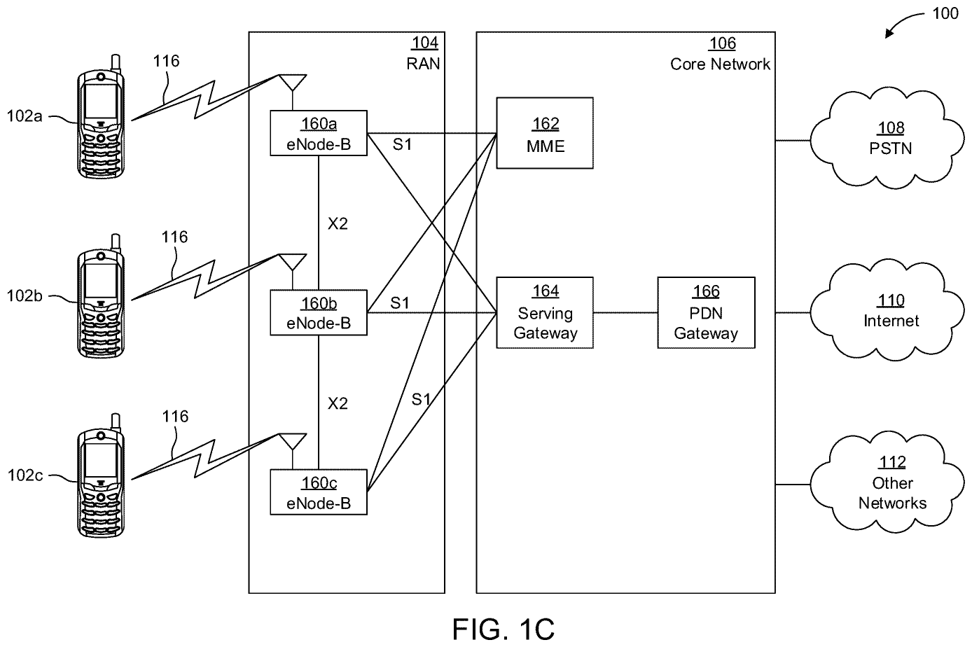

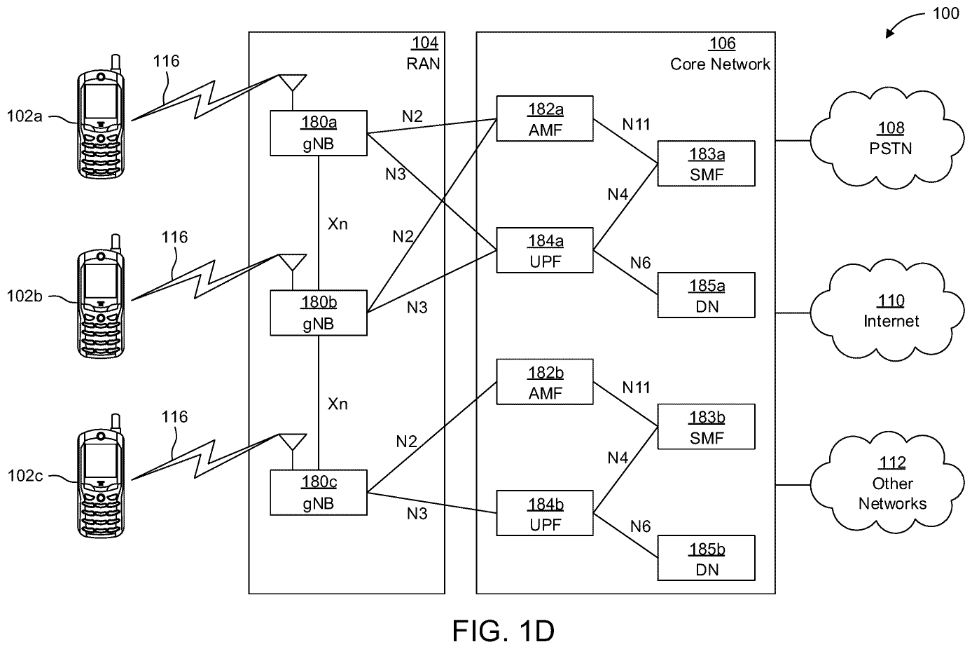

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

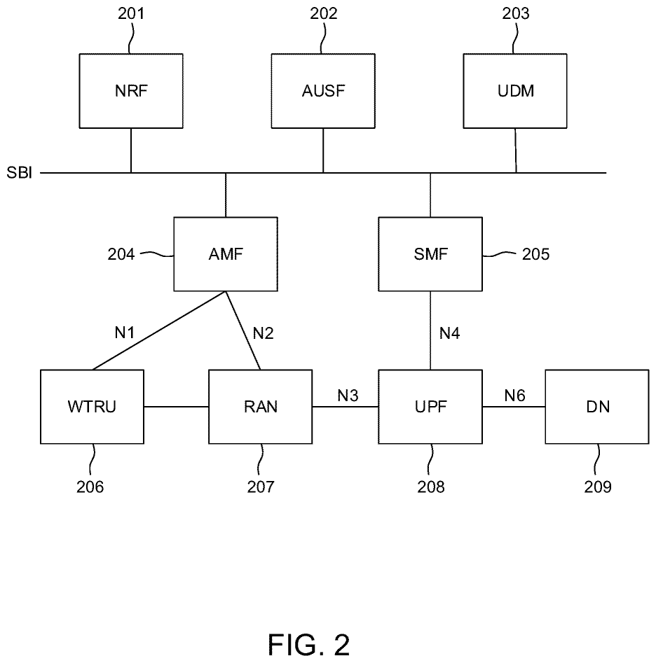

FIG. 2 illustrates an example of a 5G system architecture. In this example, only a subset of the NFs in the 5G core are represented for illustration purposes. AS shown, the NFs (e.g., AMF, SMF, UDM) may communicate with each other using Service Based Interface (SBI) (using protocols like HTTP). The goal of the Service Base Architecture (SBA) is to enable NFs to expose services (e.g., using RESTful APIs) to other NFs, for the system to provide the desired functionality.

Note that the current 5G System Architecture does not offer a full Service Based environment. While most interactions may be supported using Service Based Interfaces (SBI), there are some interfaces that still remain exclusively as point-to-point interfaces between two entities. These interfaces are shown as (Nx) and described herein, and they are different from SBI.

A WTRU may communicates with AMF over N1 using a Non-Access Stratum (NAS) protocol. Control plane messaging between the WTRU and other NFs (e.g., SMF) may be done using NAS transport encapsulation mechanism provided by AMF for the NFs.

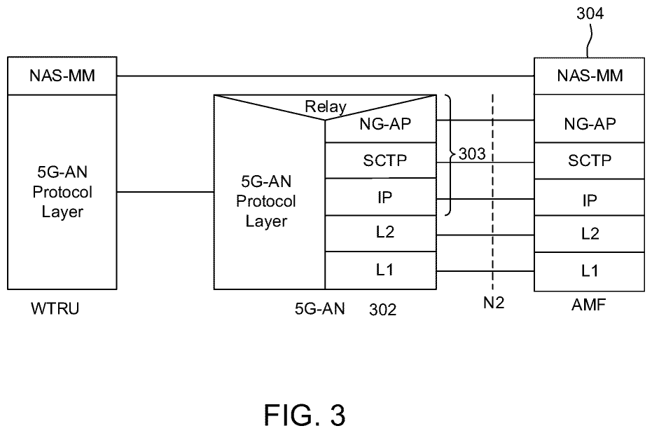

FIG. 3 illustrates an example of a control plane stack between a WTRU and an AMF. As shown, a Radio Access Network (RAN) (e.g., Access Network 302) may communicate with the AMF 304 over N2 using an NGAP protocol. Control plane messaging between the WTRU and the RAN (Access Stratum (AS)) may be done using RRC (top of the 5G-AN Protocol layers 303), which may be used to transport NAS messages received or sent by RAN over N2.

A Next Generation Network architecture, which is expected to extend SBA concepts to the RAN, may simplify network architecture (e.g., compared to 5GS) while taking advantage of cloud-native and micro-services technology to enhance architecture capabilities such as scalability, elasticity, and open interfaces.

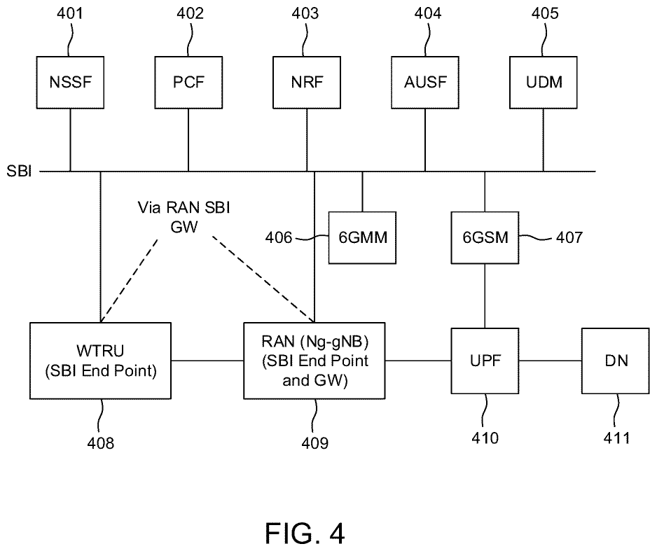

FIG. 4 illustrates an example of Next Gen Network Architecture as SBI gateway. New architecture proposals may extend the SBI framework beyond the 5GC NFs (e.g., as shown in FIG. 4). As shown, there is a NSSF 401, PCF 402, NRF 403, AUSF 404, and a UDM 405 that all may connect and/or be connected via a SBI. The SBI also allows connections to 6GMM 406, 6GSM 407, WTRU 408, RAN end point (e.g., NG-gNB) 409. A UPF 410 and DN 411 may also be accessible as well. For example, a WTRU may use an evolved NAS mechanism to exchange NAS application messages directly with one or more NFs. As an example, an SBI-compliant WTRU may establish a NAS application layer communication directly with an NF (e.g., SMF) without going through AMF (e.g., enhancing the N1 reference point to offer NAS application services over an SBI).

In one instance, a next generation network may enable “connected intelligence” where intelligent networks using AI/ML technology may be able to connect a multitude of “intelligent” things. With a huge amount of data collection from a multitude of devices (e.g., sensors, Ambient IoT) and with the added high flexibility and adaptability of AI/ML-enabled functionalities, the system may pave the way for new advanced applications such as XR/Metaverse.

In the context of next-generation wireless communication systems, there may be an evolution from a 5G System (5GS) to a 6G System (6GS), which may introduce a variety of new architectural components and enhancements aimed at addressing emerging demands such as ultra-low latency, ubiquitous intelligence, and massive connectivity. 6GS may refer to an overarching architecture and operational paradigm of the sixth-generation mobile communication system, serving as the successor to the 5GS, which characterizes a generation of standardized 5G networks. Within 6GS, a key component may be the 6G Core (6GC), which may serve as the central network architecture, analogous to the 5G Core (5GC) in a 5G system, but extended to support additional use cases such as novel requirements such as native AI integration, extreme mobility, and deterministic networking

At the access level, a Ng-gNB, or Next Generation gNodeB (e.g., which may be referred to as a base station herein, and/or interchangeable with other base stations described herein), may represent a radio access network (RAN) node in 6G architecture; in one instance, the Ng-gNB may support SBI towards the next generation Core Network, which may also be called a 6GC. The Ng-gNB may invoke directly the services needed according to the procedure being performed with the WTRU. The existing N2 interface between the gNB and AMF in the 5G architecture may be replaced with the SBI interface from the Ng-gNB to the 6GC (N2 interface from the 5GS), wherein Ng-gNB could invoke services provided by the 6GC over the SBI interface. The Ng-gNB may broadcast initial system configuration information through Master Information Blocks (MIBs) and System Information Blocks (SIBs), which may provide critical parameters for device synchronization and network attachment (e.g., to a WTRU), may include an indication about the Ng-gNB supporting SBI towards the next generation Core Network. For example, when a WTRU attempts to join a network, a Connection Management (CM) procedures are invoked to initiate or release connections.

To manage user connectivity and mobility in the 6GS, there may be one or more subsystems, such as 6G Mobility Management (6GMM) and 6G Session Management (6GSM). These, respectively, may handle tasks related to user mobility (e.g., handovers and location updates) and the establishment, modification, and termination of communication sessions. Similarly, in both 5GS and 6GS, session control may be executed by a Session Management Function (SMF), while user mobility may be overseen by an Access and Mobility Management Function (AMF). These may be categorized under broader Network Functions (NFs), which are modular service elements that collectively realize core network capabilities. For example, once the WTRU is successfully identified and authenticated, a Ng-gNB may invoke the services provided by the 6G NFs, such as registration and mobility management (6GMM), Session management (e.g., establishment, modification and/or release of PDU sessions) via 6GSM. The Ng-gNB may invoke the service of a 6G Mobility Management (6GMM) for access control or mobility updates of the WTRU. The Ng-gNB may invoke the 6GSM for session management service. The 6GSM may be an evolved version of the 5G SMF to support direct interaction with Ng-gNB for actions such as user plane resource allocation, or AN-CN tunnel establishment. Direct communication between the Ng-gNB and 6GSM may allow for a reduction of signaling overhead due to messaging with intermediate NF (e.g., AMF) compared to 5G.

Another component related to communication systems may be the User Plane Function (UPF), which may be responsible for routing user data packets to and from external data networks, identified by the Data Network Name (DNN). An Application Function (AF) may interface with a core network (CN) function(s) to enable application-level policy and/or QoS (Quality of Service) control, which may leverage a Network Exposure Function (NEF) to securely expose APIs and contextual network information to third parties. In turn, a Unified Data Management (UDM) may oversee subscriber-related data and policies across the network.

To support analytics-driven and AI-enhanced decision-making, a Network Data Analytics Function (NWDAF) may play a central role in both 5GS and 6GS by collecting data from various NFs and generating insights for performance optimization. Furthermore, 6GS may introduce a Network Initiated Request Management Function (NIRF) and Network Initiated Registration Request (NIRR) processes to facilitate proactive network-triggered procedures, such as automatic registration or session initiation in response to network events, enhancing automation and intelligence.

The Non-Access Stratum (NAS) protocol refers to a layer of communication protocols used between the WTRU and the Access and Mobility Management Function (AMF) located in the Core Network (CN) (e.g., 5GC or 6GC). The NAS protocol may operate above the Access Stratum (AS) and play a key role in managing signaling for mobility and session management.

Different mobile network functions may be based on the NAS protocol.

For example, a function based on the NAS protocol is Mobility Management (MM). The NAS protocol enables to manage location updates as the UE moves between tracking areas (TAs) and includes procedures like initial registration, deregistration, and connection management.

For example, a function based on the NAS protocol is Session Management (SM). The NAS protocol enables to establish, modify, and releases Protocol Data Unit (PDU) sessions for data transmission and support Quality of Service (QoS) management for applications.

For example, a function based on the NAS protocol is security management. The NAS protocol enables to provide mutual authentication between the UE and the Core Network (CN) network and facilitate encryption and integrity protection for NAS messages.

For example, a function based on the NAS protocol is paging coordination. The NAS protocol enables re-establishing communications with the UE when in idle mode.

For example, a function based on the NAS protocol is support for 5G system features. The NAS protocol enables slicing support, allowing the UE to connect to specific network slices based on service requirements, and enables managing dual connectivity and mobility across heterogeneous networks.

In some instances, in 5G systems the NAS protocol does not offer support for data collection and data collection session triggering or management.

The NAS protocol may ensure efficient and secure communication between a WTRU and a core network by supporting features and functions. For example, there may be functions for secure and encrypted communications, mobility support, session management, scalability (e.g., large number of devices), QoS differentiation, etc.

The NAS protocol may be extended beyond 5G networks to 6G mobile wireless system with some modifications and enhancements on the WTRU side as well as on the core network side.

Generally, a Protocol Data Unit (PDU) may represent a data encapsulation format exchanged between entities across a network, encapsulating both user and control information. The core network may support a PDU Connectivity Service, such as a service that provides an exchange of PDUs (Protocol Data Units) between a WTRU and a data network identified by a DNN (Data Network Name). The PDU Connectivity Service may be supported via PDU Sessions that are established upon request from the WTRU between the WTRU and the core network. PDU Sessions may be established (e.g., upon WTRU and/or network request), modified (e.g., upon WTRU and/or network request) and released (e.g., upon WTRU and/or network request) using NAS SM signaling (e.g., exchanged in a 5GC over N1 between the WTRU and the SMF).

In 5G architecture, the AMF may act as a single NAS termination point for the WTRU communications with the 5GC, including when the WTRU wishes to communicate with other NFs (e.g., SMF). This tight coupling between the various NFs and AMF may prevent independent scaling of the various services offered by the network (e.g., AMF vs the other NFs), pose a threat of a single point of failure, and/or delay session setup under high load scenarios. For example, a WTRU may be delayed or prevented from accessing a network slice if the AMF is experiencing a congestion condition, even if the other relevant resources (e.g., SMF, UPF) are available. The session management (SM) and/or other NFs-related procedures must go via AMF, with AMF performing routing functions rather than the actual handling of those messages.

When considering systems beyond 5G networks, these limitations need to be addressed, as well as other questions, such as: how to enhance the next generation of the mobile wireless system (e.g., 6G networks) towards a better harmonization between the radio access network (RAN) and core network functions (e.g., 6GSM, 6GMM, etc.) (e.g., avoid tight coupling using closed interfaces and redundancies); How to enhance the next generation of the mobile wireless system (e.g., 6G networks) to minimize the control plane signaling load in general; How to optimize interactions/involvement of various NFs for the WTRUs that are mostly stationary (e.g., when accessing to the network and/or when sending and receive data with data networks)?

Improvements to 5G architecture may enable new capabilities in the WTRU and the network. Some procedures may be enhanced or redefined to enable next-generation functionality.

As described herein, there are one or more approaches where a RAN node communicates with 6G NFs over a service-based interface. For example, a RAN node may communicate directly with the 6GSM NF via the SBI interface without routing the NAS Session Management messages via AMF, as was the case in 5GS. The Non-Access Stratum (NAS) termination, which was at AMF in the 5GS, may be distributed across various 6G NFs, such as where the Session Management terminates at the 6GSM with direct interface from RAN node to 6GSM, 6GSM messages are ciphered and/or integrity protected with the 6GSM security context (e.g., ciphering and integrity protection with 6GSM security keys) end to end (e.g., WTRU to 6GSM). Session management procedures (PDU Session Establishment, modification, release) may take into consideration new/modified network architecture, new/modified approaches for managing session management context, and communication based on the SBI interface among various network functions. Additional functionality may be added to various network functions to enable PDU session-related procedures, such as PDU session establishment, modification, and/or release.

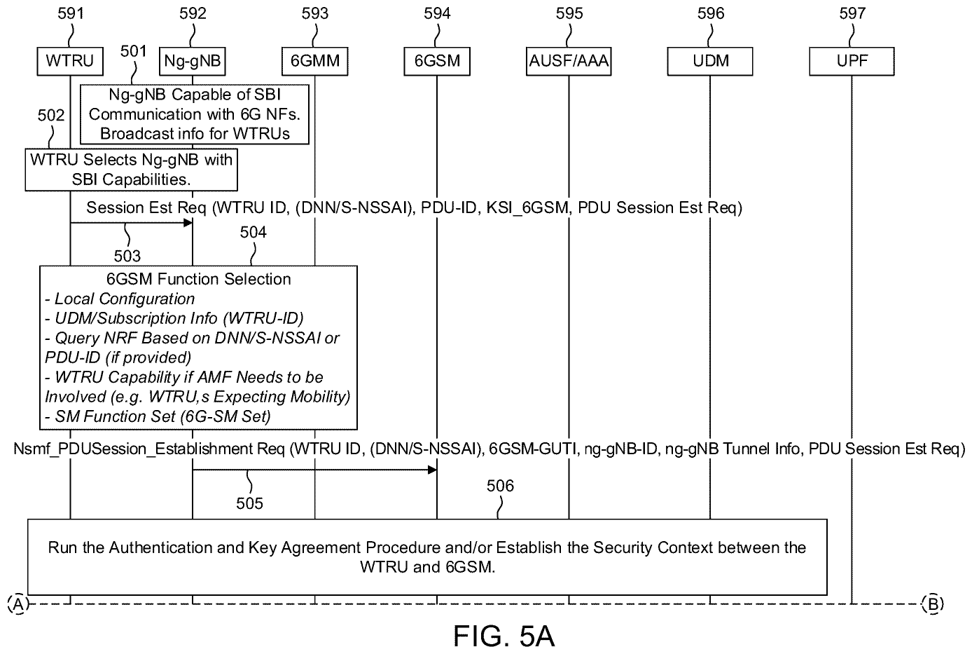

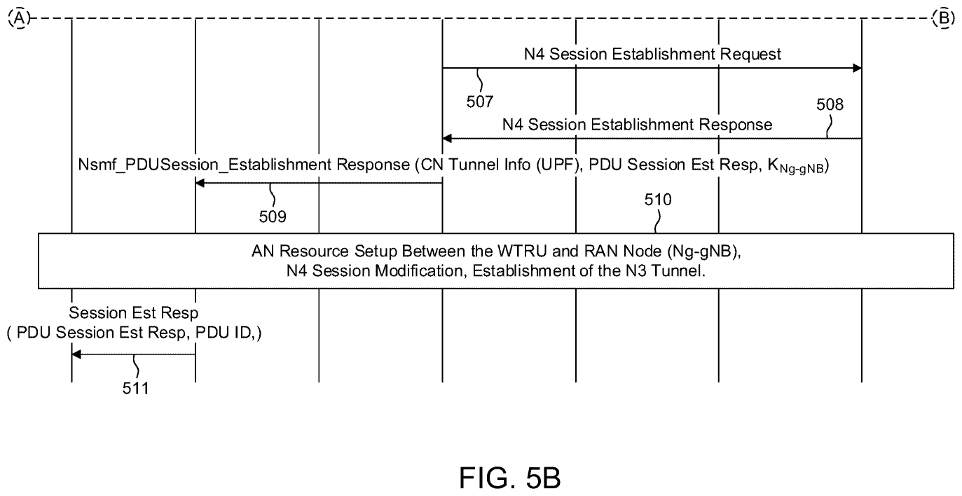

FIG. 5 illustrates an example of a PDU establishment procedure (FIG. 5a and FIG. 5b are collectively referred to FIG. 5 herein). As shown, there may be a WTRU 591, a Ng-gNB 592, 6GMM 593, 6GSM 594, AUSF/AAA 595, UDM 596, and/or a 597 UPF.

At 501, the Ng-gNB (6G RAN Node), which may communicate with the 6G NFs (e.g., 6GMM and 6GSM) over a serviced based interface (SBI), may broadcast information about support of SBI on a broadcast channel (e.g., System Information Block (SIBs) and/or MIBs, either of which are interchangeable with system information) for one or more WTRUs.

At 502, a WTRU(s) (e.g., that is 6G or beyond 5G capable)(e.g., that received the system information) may select a RAN node with SBI-capable communication with the 6G NFs. The WTRU may make a decision about selecting a RAN node that is capable of SBI interface to the core network functions based on its local configuration, user preference, preference stored in a SIM card, support of distributed NAS capabilities, etc. The SBI capability may be identified by the WTRU with the presence of the indication in the system information for support of SBI communication by the RAN node (e.g., Ng-gNB) with the 6G core network functions.

At 503, the WTRU may initiate/send a Session Establishment Request message to the Ng-gNB. To transport the Session Establishment Request message, the WTRU may establish an RRC connection with the Ng-gNB. The message may include a WTRU identifier (WTRU-ID), a Data Network name and slice identifier combination (DNN/S-NSSAI), a PDU Session identifier (PDU-ID), a Key Set Identifier (KSI_6GSM) (e.g., if available from previous authentication and authorization procedure run between the UE and 6GSM), and/or a PDU session establishment request message. The WTRU may protect the privacy-sensitive parameters (e.g., S-NSSAI) using the security context identified by KSI_6GSM (e.g., using confidentiality and integrity keys K_{6GSMenc}, K_{6GSMint}). Alternatively, if no security context is established, the WTRU may send the privacy-sensitive parameters later in the procedure in a secure message (e.g., during key agreement at 506). The AS layer security may already be established as described at 506 and used by the WTRU to send an initial PDU Session message over a secure AS layer connection with the RAN node.

At 504, the Ng-gNB, upon reception of the Session Establishment Request message in the previous step, may trigger a procedure for selection of the 6GSM entity that will be used by the WTRU for establishment of the PDU session. The selection of the 6GSM entity may be dependent on one or more parameter/factors, such as but not limited to local configuration, UDM/Subscription information, Query NRF information, WTRU capability information, 6GSM pooling information, established PDU session information, and/or any other factor discussed herein.

For local configuration information, the selection of the 6GSM entity may be based on the local configuration at the Ng-gNB. The Ng-gNB may be configured with the 6GSM Identifier that shall be selected as a default session management function for the requesting WTRU's when other factors do not yield any other session management function.

For the UDM/Subscription information, the Ng-gNB may query the UDM/Subscription database with WTRU-ID as the data key to retrieve information about the applicable and suitable 6GSM for the requesting WTRU.

For Query NRF information, the Ng-gNB may query the network repository function (NRF) with the DNN/S-NSSAI or PDU-ID as the data key to retrieve information about a suitable session management function (6GSM) for the requesting WTRU.

For WTRU capabilities information, the Ng-gNB may take into consideration the WTRU capabilities (e.g., a normal WTRU with mobility support vs an IoT device that has minimal mobility requirements to decide on which 6GSM entity shall be used for the PDU session establishment). The Ng-gNB may query the 6GMM function to retrieve information about the 6GSM entity that may serve the WTRU.

For 6GSM pooling information, if the 6G Core network supports 6GSM pooling functionality (e.g., multiple 6GSM grouped together to form a 6GSM pool), the Ng-gNB may dynamically select a 6GSM from the 6GSM pool based on a configured policy. This pooling of the 6GSM may help with scalability, redundancy, and/or load balancing.

For established PDU sessions information, in case there is already established PDU Sessions for the WTRU, the Ng-gNB may use this information to select the same 6GSM entity that is already serving the WTRU. The 6GSM may use a temporary identifier 6GSM-GUTI (e.g., something like GUTI in 5G, which has a temporary identifier and/or a globally unique identifier to identify the anchor 6G NF, e.g., 6GSM), which may be used in subsequent PDU session request by the WTRU, which may be used by the Ng-gNB node to identify if the 6GSM security context has already been established between the 6GSM and WTRU and/or the identification of the anchor 6GSM entity which carried out the initial security procedure between the WTRU and the 6GSM.

At 505, the 6GSM may have been selected by the Ng-gNB, and the Ng-gNB may invoke a service Nsmf_PDUSession_Establishment_Req and pass on the PDU session establishment request message received from the WTRU to the 6GSM entity. In one instance, the Ng-gNB may also send along additional information provided by the WTRU, such as the WTRU-ID, DNN/S-NSSAI, PDU-ID along with the Ng-gNB Identifier and Ng-gNB (Access Network) Tunnel information (Ng-gNB Tunnel Endpoint identifier Ng-gNB TEID and Ng-gNB IP address information for the downlink traffic), 6GSM GUTI, and/or other information described herein. After selecting 6GSM for the requested PDU session, the Ng-gNB may store the mapping between PDU session ID and selected 6GSM information. This information may be utilized during PDU session modification procedure(s) to determine the 6GSM entity by the RAN node (e.g., Ng-gNB). Alternatively, this mapping information may be stored in some other NF (e.g., UDM/NRF, etc.). If the WTRU has provided a valid 6GSM GUTI (e.g., 6GSM security context has already been established between the WTRU and the anchor 6GSM entity), then a security procedure (e.g., such as described herein, such as with respect to the security/authentication performed at 506, etc.) may not be performed. The 6GSM entity may communicate with the anchor 6GSM entity to retrieve the 6GSM security context. In case no valid 6GSM GUTI is provided or 6GSM GUTI cannot be resolved, 6GSM entity may perform security process 506 to carry out the authentication and authorization procedure and establish 6GSM security context.

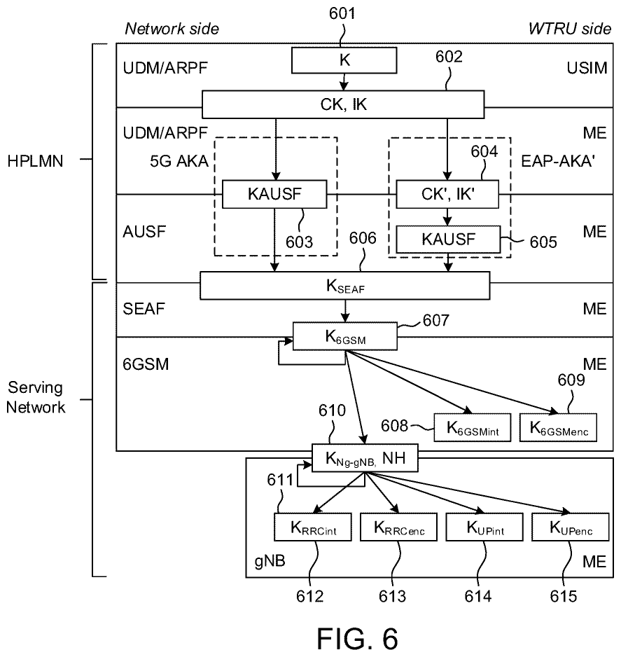

At 506, a primary authentication and key agreement procedure may be performed (e.g., such as a security procedure described herein, or a variation of a security procedure described herein with one or more steps omitted, modified, etc.). For example, this security procedure may be between one or more NFs, such as 6GSM/SEAF<->AUSF<->UDM. A Security Anchor Function (SEAF) may be the logical function that resides in the 6GSM. The 6GSM may be the entity that is the security anchor for initiating the security procedure, and the security procedure may be carried out between the WTRU and 6GSM as the endpoints. The 6GSM and mobility entity (ME) (e.g., WTRU) may derive new key sets (e.g., 6GSM and RRC specific), such as K_{6GSM}, K_{6GSMint}, K_{6GSMenc}, K_{Ng-gNB} as per the key hierarchy and key derivation (e.g., described with regard to FIG. 6).

Alternatively, the AS security may be established in another manner from a previous interaction (e.g., Registration, Service Request procedures, etc.) between the WTRU and a network anchor function (e.g., AMF). The WTRU may maintain multiple NAS contexts with different SMFs sharing a common AS security used with the RAN node.

Alternatively, the Security Anchor Function (SEAF) may be an independent entity that is accessible by various other 6G NFs (e.g., 6GSM). This may enable different 6GSM entities within the 6G core network to access authentication and authorization services provided by the SEAF.

Once the security procedure is performed, then the 6GSM security context may be established between the WTRU <->6GSM via the 6GSM Security Mode Command/Complete message transfer between the UE and 6GSM. Once the 6GSM security is established, all messages between the UE and 6GSM are ciphered and integrity-protected using the established 6GSM security context and 6GSM security keys, such as K_{6GSMint} and K_{6GSMenc}. KSI_6GSM is the key set identifier which is associated with the security context and set of security keys. Successful 6GSM Security context is saved in the UDR (central repository), to be shared with other 6GSM NFs belonging to the same 6GSM Pool set.

Here, the 6GSM GUTI may be generated that may be used to identity the anchor 6GSM entity that has established the 6GSM security context with the WTRU. The Access Stratum level security may be established between the WTRU and Ng-gNB, via AS Security Mode Command/Complete message transfer between the WTRU and Ng-gNB. The WTRU may use the K_{Ng-gNB} to derive the K_{RRCint}, K_{RRCEnc} for ciphering and integrity protection of the RRC control plane messages and use K_{UPenc} and K_{UPint} for the protection of UP traffic between the WTRU and Ng-gNB.

At 507 and 508, the 6GSM may initiate an N4 Session Establishment procedure with the selected UPF. The 6GSM may send an N4 Session Establishment Request to the UPF and provides Packet detection, enforcement and reporting rules to be installed on the UPF for the PDU Session. The UPF may acknowledge by sending an N4 Session Establishment Response. The requested CN Tunnel Info (e.g., TEID and IP address) may be provided to 6GSM by the UPF.

At 509, the 6GSM may respond to the Ng-gNB with the Nsmf_PDUSession_Establishement_Response including the CN Tunnel Info from the UPF (e.g., TEID and UPF IP address), PDU Session Est Response to be sent to the WTRU.

At 510, the Ng-gNB may setup the access network (AN) resources for the PDU Session, such as RRC Connection Reconfiguration may take place with the WTRU establishing the necessary RAN resources related to the QoS Rules for the PDU session. The Ng-gNB may allocate AN Tunnel Info for the PDU Session. The AN Tunnel Info may include a tunnel endpoint for the Ng-gNB. There may be an information exchange between the Ng-gNB and 6GSM, wherein the Ng-gNB shares information about the AN Tunnel info with 6GSM. Based on reception of the AN tunnel info the 6GSM may trigger N4 Session Modification procedure with the UPF and the 6GSM may share the AN Tunnel info received from the Ng-gNB. After this, the N3 tunnel may be established between the Ng-gNB and UPF and user traffic may be exchanged between the WTRU and external data network.

At 511, the Ng-gNB may respond to the WTRU with the Session Est Response including the PDU session Est Response along with the PDU ID that uniquely identifies the successfully established PDU Session.

The procedure of FIG. 5 may be optimized for a subsequent PDU Session establishment with another 6GSM (new 6GSM). For example, the mutual authentication between the UE and the network (new 6GSM, AUSF) at 506 may not be performed by leveraging the existing security context with old 6GSM. The new 6GSM may check whether the WTRU has already been authenticated from a prior SM session. In an example, the new 6GSM may retrieve information about the old 6GSM from a common storage function (e.g., UDM/UDR), where the old 6GSM has sent its info for storage during a successful procedure (e.g., as described herein). The new 6GSM may locate the old 6GSM based on parameters that the WTRU provides in the PDU Session establishment request message (e.g., KSI_6GSM, old PDU Session ID, etc.). The old 6GSM may derive a new K_{6GSM} using the old K_{6GSM} and other parameters (e.g., a freshness parameter/nonce sent by the WTRU in the PDU Session establishment request message, a NAS counter maintained between the WTRU and old 6GSM, PDU Session ID, etc.). The new 6GSM may use the new K_{6GSM} received from the old 6GSM to derive the security keys that may be derived using the same input as indicated by the old 6GSM (e.g., Algorithm ID). The WTRU may derive the security the same way. A key agreement may be skipped with this mechanism. The new 6GSM may protect the PDU Session establishment accept message using the newly derived security keys. The WTRU may verify the message and decrypt using the newly derived security keys. The 6GSMs may belong to the same 6GSM pool or a different pool. Alternatively, new K_{6GSM} may be derived from K_{SEAF} and parameters for session management information (e.g., PDU ID, DNN, etc.), In this case, K_{6GSM} may be derived by the old 6GSM anchoring SEAF and provided to the new 6GSM.

FIG. 6 illustrates an example of a key hierarchy generation in 6GS with 6GSM as a security anchor. K 601 may be a long-term subscriber key stored in a USIM on a WTRU side and/or in a UDM/ARPF. This key may be the root of trust for generating additional keys (e.g., as shown). Cipher Key (CK) 602 and/or Integrity Key (IK) may be derived from K 601, and these may be used in 5G AKA or EAP-AKA′ (e.g., as described herein). In an example, for the 5G AKA path the CK/IK may be used to derive key for an Authentication Server Function (KAUSF) 603. In an example, for the EAP-AKA′ path 604 CK′/IK′ may be derived, which may be used to derive KAUSF. K_{SEAF} 606 may be derived from KAUSF 603/605, and may be sent to the SEAF and/or ME. This key may act as an anchor for session-specific security.

K_{6GSM} 607 is a key derived by ME (WTRU) and SEAF from K_{SEAF} 606. There may be one or more Keys for session management signaling, such as but not limited to: K_{6GSMint} 608, K_{6GSMenc} 609, K_{Ng-gNB} 610, K_{UPenc} 615, K_{UPint} 614.

K_{6GSMint} 608 is a key derived by ME and 6GSM from K_{6GSM} 607, which may (e.g., only) be used for the protection of Session Management signalling with a particular integrity algorithm.

K_{6GSMenc} 609 is a key derived by ME and 6GSM from 607 K_{6GSM}, which may (e.g., only) be used for the protection of Session Management signalling with a particular encryption algorithm.

There may a Key for Ng-gNB such as but not limited to 610 K_{Ng-gNB}, which is a key derived by ME and 6GSM from K_{6GSM} 607.

There may be one or more keys for UP traffic, such as but not limited to: K_{UPenc}, 615 and/or K_{UPint} 614.

K_{UPenc} 615 is a key derived by ME and Ng-gNB from K_{Ng-gNB} 610, which may (e.g., only) be used for the protection of UP traffic with a particular encryption algorithm.

K_{UPint} 614 is a key derived by ME and Ng-gNB from 610 K_{Ng-gNB}, which may (e.g., only) be used for the protection of UP traffic between ME and gNB with a particular integrity algorithm.

There may be one or more for RRC signaling, such as but not limited to: K_{RRCenc}, 613 and/or K_{RRCint} 612.

K_{RRCenc} 613 is a key derived by ME and Ng-gNB from K_{Ng-gNB} 610, which may (e.g., only) be used for the protection of RRC Signaling with a particular encryption algorithm.

K_{RRCint} 612 is a key derived by ME and Ng-gNB from K_{Ng-gNB} 610, which may (e.g., only) be used for the protection of RRC Signaling with a particular integrity algorithm.

In one example, there may be an authentication procedure for EAP-AKA′ (Extensible Authentication Protocol Method for 3GPP Authentication and Key Agreement-primary) that involves a sequence of interactions among several core network entities (e.g., 5G), including the UDM/ARPF, AUSF, SEAF, and the WTRU. Initially, the UDM/ARPF may generate an authentication vector (AV) with a specific AMF separation bit set to 1, indicating its use for EAP-AKA′. It then computes derived ciphering and integrity keys (CK′ and IK′) and constructs a modified authentication vector AV'. This vector may be sent to the AUSF, along with an indication that it is to be used for EAP-AKA′. The AUSF may then respond to the SEAF with an EAP-Request/AKA′-Challenge message, which the SEAF forwards to the WTRU in a NAS Authentication Request. The WTRU's Mobile Equipment (ME) may pass the challenge to the USIM, which checks the validity of the AUTN parameter to verify the freshness of the AV′. Upon successful validation, the USIM may compute a response (RES) and return it along with CK and IK to the ME, which then computes CK′ and IK′ for the continued procedure.

The WTRU may then sends an EAP-Response/AKA′-Challenge to the SEAF, which forwards it to the AUSF for verification. If the AUSF confirms that the RES matches the expected XRES, the authentication proceeds, and optional EAP notifications may be exchanged. The AUSF may derive the Extended Master Session Key (EMSK) from CK′ and IK′, from which it obtains KAUSF and subsequently derives the anchor key KSEAF. This key may then be sent to the SEAF within an EAP Success message and may also be transparently forwarded to the WTRU. If applicable, the SUPI may be included in this message. The SEAF may use the received KSEAF, ABBA parameter, and SUPI to derive the KAMF and transmit it to the AMF, finalizing the security context. Concurrently, the WTRU may perform similar derivations to establish KSEAF and KAMF. Temporary security contexts may be created by the WTRU during this process and are either solidified upon successful authentication or discarded upon failure. This mechanism ensures mutual authentication, secure key derivation, and prepares the WTRU and network for secure communication under a 5G system architecture, but may be applicable (in part or in whole) to other generation architectures.

In one example, there may be a 5G Authentication and Key Agreement (5G AKA) procedure may be an authentication framework within the 5G system that ensures mutual authentication between the WTRU and the core network. It may involve several functional entities, including the Unified Data Management (UDM), Authentication Credential Repository and Processing Function (ARPF), Authentication Server Function (AUSF), and Security Anchor Function (SEAF). The example procedure may begin when the UDM/ARPF receives a Nudm_UEAuthentication_Get Request from the AUSF. In response, the UDM/ARPF may generate a 5G Home Environment Authentication Vector (5G HE AV). This vector may include a Random challenge (RAND), Authentication Token (AUTN), an Expected Response value (XRES*), and/or an anchor key known as the Key Access Security Management Function (KAUSF). The UDM/ARPF sets the Authentication Management Field (AMF) separation bit to “1” and may compute the relevant cryptographic values based on annexed derivation functions.

The 5G HE AV may then be returned to the AUSF in a Nudm_UEAuthentication_Get Response message. If the initial request included the Subscription Concealed Identifier (SUCI), the UDM returns the Subscription Permanent Identifier (SUPI) after decrypting the SUCI using the Subscription Identifier De-concealing Function (SIDF). If the subscriber is provisioned for Authentication and Key Management for Applications (AKMA), the UDM also includes the relevant AKMA indication and Routing Indicator in the response.

Upon receiving this vector, the AUSF may temporarily store the XRES* and associated SUCI or SUPI. It may then derive the 5G Serving Environment Authentication Vector (5G SE AV) by calculating the Hashed Expected Response (HXRES*) from XRES*, and deriving the Key for SEAF (KSEAF) from KAUSF. The AUSF may then remove the KSEAF from the vector and forward the RAND, AUTN, and/or HXRES* to the SEAF in a Nausf_UEAuthentication_Authenticate Response.

The SEAF may deliver the challenge to the WTRU in a Non-Access Stratum (NAS) Authentication Request message. This message may also include the Next Generation Key Set Identifier (ngKSI), used by both the WTRU and the Access and Mobility Management Function (AMF) to reference the security context, and the Authentication Binding and Bidding Attack (ABBA) parameter, which safeguards against security downgrades. The Mobile Equipment (ME) within the WTRU may pass the RAND and AUTN to the Universal Subscriber Identity Module (USIM).

Upon receiving the challenge, the USIM may verify the freshness of the authentication vector by validating AUTN. If successful, the USIM computes a Response (RES) along with the Cipher Key (CK) and Integrity Key (IK), and returns them to the ME. If the USIM also derives a legacy General Packet Radio Service (GPRS) key (Kc), the ME may be instructed to discard it. The ME then derives the final response RES*, recalculates KAUSF using CK and IK, and derives KSEAF from KAUSF. It also checks that the separation bit in the AMF field of AUTN is correctly set to 1 to ensure the procedure aligns with 5G authentication.

The WTRU may then return RES* to the SEAF in a NAS Authentication Response message. The SEAF may compute HRES* from RES* and compare it with the previously received HXRES*. If they match, authentication may be considered successful from the serving network's perspective. If RES* is not received (e.g., due to WTRU unavailability), authentication is considered failed. The SEAF then forwards RES* to the AUSF in a Nausf_UEAuthentication_Authenticate Request.

On receiving this message, the AUSF first checks whether the 5G AV has expired. If valid, it compares RES* with the stored XRES*. If they match, the authentication is deemed successful from the home network's perspective. The AUSF notifies the UDM of the result and, if successful, returns the KSEAF and potentially the SUPI (if SUCI was used initially) in a Nausf_UEAuthentication_Authenticate Response.

The SEAF may then treat the received KSEAF as the anchor key and uses it, along with the ABBA parameter and SUPI, to derive the Key Access Management Function (KAMF), which is forwarded to the AMF along with the ngKSI. If the authentication used SUCI, the SEAF withholds ngKSI and KAMF from the AMF until the SUPI is available, ensuring no communication services are provided until the WTRU's identity is verified. The AMF may then initiate the NAS Security Mode Command procedure with the WTRU to activate the new security context. Once the WTRU successfully processes this command, the primary authentication is considered complete.

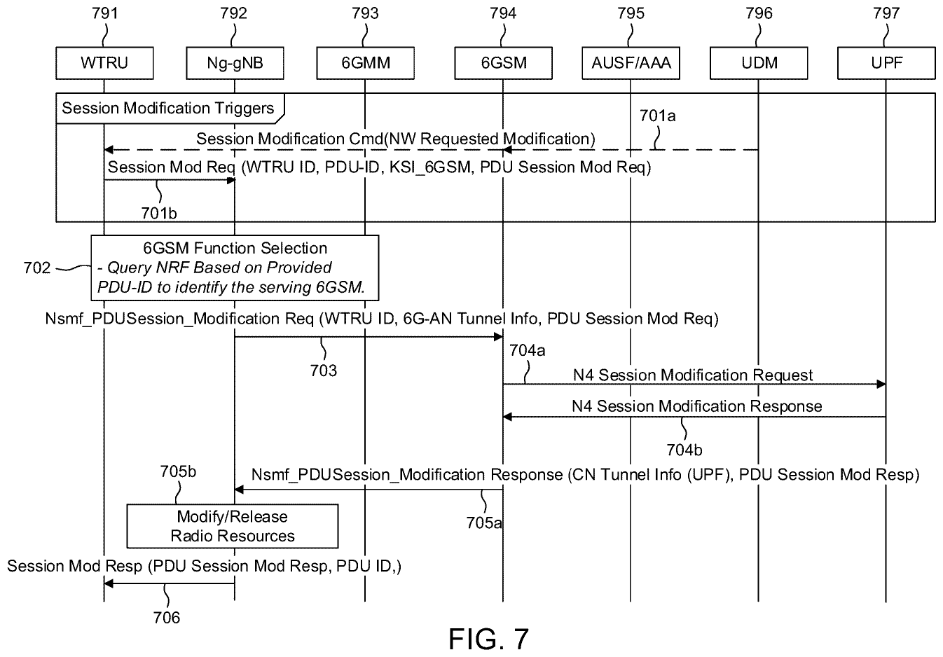

FIG. 7 illustrates an example of a PDU session modification procedure. In this example there may be a WTRU 791, a Ng-gNB 792, a 6GMM 793, a 6GSM 794, AUSF/AAA 795, UDM 796, and/or a UPF 797. At 701 (701a, 701b) a WTRU or Network may trigger a modification of an existing PDU Session between the WTRU and 6GSM.

The 6GSM may decide to modify the PDU Session. This procedure may be triggered based on a locally configured policy in the 6GSM, UDM updates of the subscription data of the WTRU resulting in modifications of the existing PDU session, or there may be other triggers (e.g., AF/6GMM/PCF/Access Network (RAN) initiated, e.g., or as a result of other NFs in the 6GC, etc.). T he WTRU may initiate the PDU Session Modification procedure by the transmission of Session Mod Req along with a WTRU ID, PDU-ID to identify the PDU session to be modified, KSI_6GSM, and/or a PDU Session Mod Req message.

At 702, if the WTRU caused the trigger of the PDU Session modification (701b), the Ng-gNB may query the network repository function (NRF) with the provided PDU-ID as the data key to retrieve information about the session management function (6GSM) that is serving the PDU session identified with the WTRU provided PDU ID. Alternatively, the Ng-gNB may have the mapping information for the PDU Session ID and corresponding 6GSM entity, or this information may be stored in another 6G Network functions (e.g., UDM/UDR and retrieved by the Ng-gNB).

At 703, the 6GSM may be selected by the Ng-gNB, where the Ng-gNB may invoke the service Nsmf_PDUSession_Modification_Req and pass on the PDU session modification request message received from the WTRU to the 6GSM entity. In one instance, Ng-gNB may also pass along the additional information provided by the WTRU (e.g., WTRU-ID, AN-Tunnel Info, such as the TEID and IP Address of the Ng-gNB GTP Tunnel) (e.g., PDU Session Mod Req message).

At 704 (704 a/704b), the 6GSM may initiate an N4 Session Modification procedure with the selected UPF. The 6GSM may send an N4 Session Modification Request to the UPF and provide Packet detection, enforcement, and/or reporting rules to be installed on the UPF for the PDU Session. The UPF may acknowledge this by sending an N4 Session Modification Response. The requested CN Tunnel Info (e.g., TEID and IP address) may be provided to 6GSM by the UPF.

At 705 (705a705b) the 6GSM may respond to the Ng-gNB with the Nsmf_PDUSession_Modification_Response including the CN Tunnel Info from the UPF (e.g., TEID and UPF IP address) and/or a PDU Session Mod Response to be sent to the WTRU. The Ng-gNB may issue an AN specific signaling exchange with the WTRU that is related to the information received from 6GSM. For example, in the case of a NG-RAN, an RRC Connection Reconfiguration may take place with the WTRU modifying the necessary (R)AN resources related to the PDU Session.

At 706, the Ng-gNB may respond back to the WTRU with the Session Mod Response including the PDU session Mod Response message along with the PDU ID which uniquely identifies the successfully modified PDU Session.

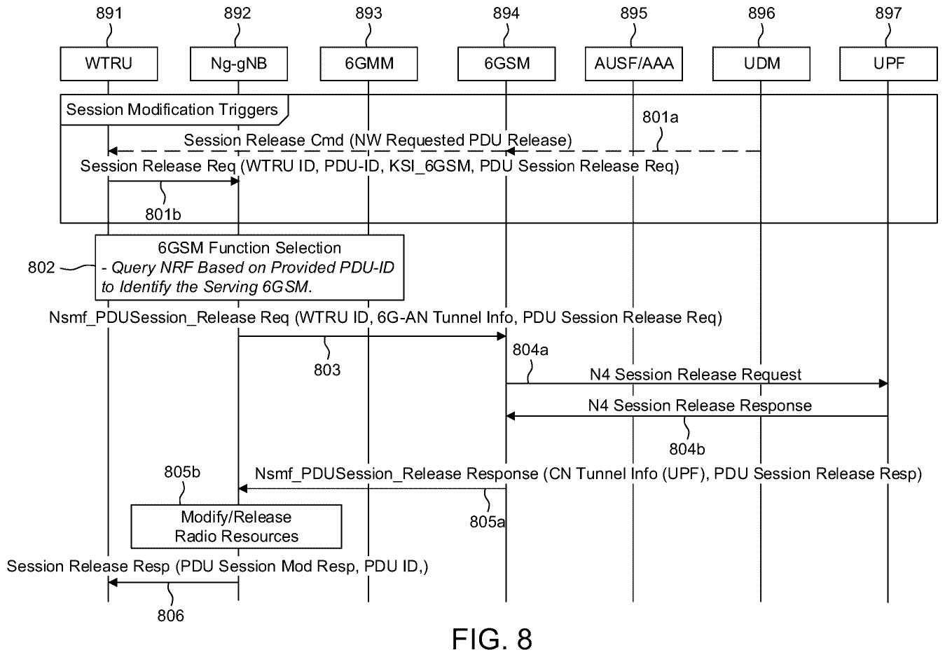

FIG. 8 illustrates an example of a PDU session release procedure. In this example there may be a WTRU 891, a Ng-gNB 892, a 6GMM 893, a 6GSM 894, AUSF/AAA 895, UDM 896, and/or a UPF 897.

At 801 (801a/802b), a WTRU or a network may trigger the release of an existing PDU Session between the WTRU and 6GSM. The PDU Session Release procedure may be used to release all the resources associated with a PDU Session, including, but not limited to, IP Address/Prefixes allocated for an IP based PDU Session, UPF resources used by the PDU session, and/or any access resources used by the access network for the PDU session.

In one instance of the procedure, the WTRU may request the release of one PDU Session.

In one instance of the procedure, the 6GMM, the 6GSM, or the PCF may initiate the release of a PDU Session.

The WTRU may initiate the PDU Session release procedure by the transmission of a Session Release Req along with the WTRU ID, PDU-ID to identify the PDU session to be released, KSI_6GSM, and/or PDU Session Release Req message.

At 802, the Ng-gNB may query the network repository function (NRF) with the provided PDU-ID as the data key to retrieve information about the session management function (6GSM) serving the PDU session identified with the WTRU-provided PDU ID.

At 803, the 6GSM may be selected by the Ng-gNB, and the Ng-gNB may invoke the service Nsmf_PDUSession_Release_Req and pass on the PDU session release request message received from the WTRU to the 6GSM entity. In one instance, the Nh-gNB may pass along the additional information provided by the WTRU (e.g., WTRU-ID, AN-Tunnel Info (e.g., TEID and IP Address of the Ng-gNB GTP Tunnel), and/or PDU Session Release Req message.

At 804 (804a/804b) the 6GSM may initiate an N4 Session Release procedure with the selected UPF. The 6GSM may send an N4 Session Release Request to the UPF. The UPF(s) may drop any remaining packets of the PDU Session and release all tunnel resources and contexts associated with the N4 Session. The UPF(s) may acknowledge the N4 Session Release Request by the transmission of an N4 Session Release Response message to the 6GSM.

At 805(a/b) the 6GSM may respond to the Ng-gNB with the Nsmf_PDUSession_Release_Response including the CN Tunnel Info from the UPF (e.g., TEID and UPF IP address), and/or PDU Session Release Response to be sent to the WTRU. When the Ng-gNB has received an 6GSM request to release the AN resource associated with the PDU Session it may issue an AN specific signaling exchange(s) with the WTRU to release the corresponding AN resources.

At 806, the Ng-gNB may respond back to the WTRU with the Session Release Response including the PDU session Release Response message along with the PDU ID that uniquely identifies the successfully released PDU Session.

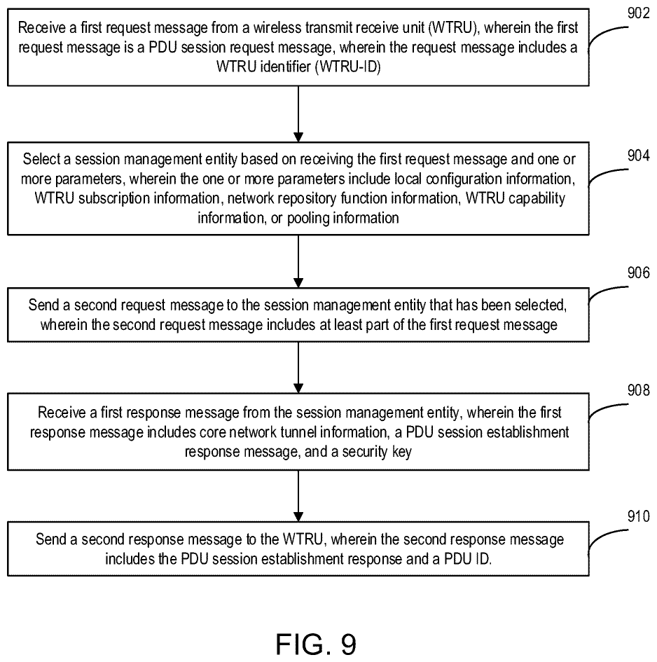

FIG. 9 illustrates an example flow diagram. As shown, a base station at 902 may receive a first request message from a wireless transmit receive unit (WTRU). The first request message may be a PDU session request message. The request message may include a WTRU identifier (WTRU-ID). At 904, the base station may select a session management entity based on receiving the first request message and one or more parameters, wherein the one or more parameters include local configuration information, WTRU subscription information, network repository function information, WTRU capability information, and/or pooling information. At 906, the base station may send a second request message to the session management entity that has been selected. The second request message may include at least part of the first request message. At 908, the base station may receive a first response message from the session management entity. The first response message may include core network tunnel information, a PDU session establishment response message, and/or a security key. At 910, the base station may send a second response message to the WTRU. The second response message may include the PDU session establishment response and/or a PDU ID.

In an example, a RAN Node, such as a base station (e.g., NG-gNB) may perform a method for evolved session management. The base station may receive the Session Establishment Request message from the WTRU. The message may include a WTRU identifier (WTRU-ID), DNN/S-NSSAI (Data Network name and slice identifier combination), PDU Session identifier if available from earlier established PDU session (PDU-ID), KSI_6GSM (e.g., Key Set Identifier, if available from previous authentication and authorization procedure run between the WTRU and 6GSM) and PDU session establishment request message.

The Ng-gNB, on reception of the Session Establishment Request message, may trigger the procedure for selection of the 6GSM entity that may be used by the WTRU for establishment of the PDU session. The selection of the 6GSM entity may be dependent on one or more factors.

One factor may be Local Configuration. The Selection of the 6GSM entity may be based on the local configuration at the Ng-gNB. The Ng-gNB could be configured with the 6GSM Identifier which shall be selected as a default session management function for requesting WTRU's when other factors do not yield any other session management function.

One factor may be UDM/Subscription Info. The Ng-gNB may query the UDM/Subscription database with WTRU-ID (UE identifier) as the data key to retrieve information about the applicable and suitable 6GSM for the requesting WTRU.

One factor may be Query NRF. The Ng-gNB may query the NRF (network repository function) with the DNN/S-NSSAI or PDU-ID as the data key to retrieve information about the suitable session management function (6GSM).

One factor may be WTRU Capabilities. The Ng-gNB may take into consideration the WTRU capabilities, such as a normal UE with mobility support vs an IoT device which has minimal mobility to decide on which 6GSM entity shall be used for the PDU session establishment. The Ng-gNB may query the 6GMM function to retrieve information about the 6GSM entity which shall serve the WTRU.

One factor may be 6GSM Pooling-If the 6G Core network support 6GSM pooling functionality (multiple 6GSM can be grouped together to form a 6GSM Pool), the Ng-gNB can dynamically select an 6GSM from the 6GSM Pool based on the configured policies. This pooling of the 6GSM helps with the scalability, redundancy and load balancing.

Once the 6GSM has been selected by the Ng-gNB, the Ng-gNB invokes the service Nsmf_PDUSession_Establishment_Req and pass on the PDU session establishment request message received from the WTRU to the 6GSM entity along with the additional information provided by the WTRU, such as WTRU-ID, DNN/S-NSSAI, optional PDU-ID along with the Ng-gNB Identifier and Ng-gNB Tunnel information (Ng-gNB Tunnel Endpoint identifier Ng-gNB TEID and Ng-gNB IP address information for the downlink traffic).

The Ng-gNB on reception of Nsmf_PDUSession_Establishement_Response from the 6GSM including the CN Tunnel Info from the UPF (TEID and UPF IP address), PDU Session Est Response and Ng-gNB security key for establishing secure communication between the WTRU and RAN node (Ng-gNB) triggers the AS security establishment between the Ng-gNB and UE. Once the AS security has been established successfully, the Ng-gNB responds to the WTRU with the Session Est Response message with successful establishment of the PDU session.

In one example, a base station may initiate a process by receiving a primary request message from a wireless transmit-receive unit (WTRU), identified as a PDU session request message. This request may include a WTRU identifier (WTRU-ID), establishing a unique context for the communication. Upon receiving the request, the base station may perform the task of selecting a session management entity. This selection may be determined based on multiple factors, including local configuration information, WTRU subscription data, network repository function information, WTRU capability parameters, and/or pooling information. Subsequently, the base station may forward a secondary request message to the chosen session management entity. This secondary message may incorporate relevant elements of the initial request message to maintain continuity of information.

The session management entity may then respond with a primary response message, providing details such as core network tunnel information, a PDU session establishment response, and/or a security key. Following this, the base station may transmit a secondary response message to the WTRU, which includes the PDU session establishment response and/or an associated PDU identifier.

The initial request message may include additional information such as a Data Network name and slice identifier combination (DNN/S-NSSAI), an earlier PDU session identifier (PDU-ID), a preceding Key Set Identifier (KSI), and/or WTRU capability information. Furthermore, specific components of the initial request message, such as DNN/S-NSSAI, earlier PDU-ID, or earlier KSI, may be incorporated into the subsequent request message. The secondary request message may also include base station tunnel information, such as an IP address designated for downlink traffic.

In scenarios requiring enhanced security measures, a sequence of messages may be exchanged between the WTRU and the base station to establish access stratum (AS) security prior to transmitting the secondary response message. Additionally, preceding the reception of the initial request, the base station may receive messages encompassing local configuration, subscription data, network repository function details, or pooling parameters. The base station may broadcast a message indicating service-based interface capability information to the WTRU before processing the initial request.

This approach may apply to PDU sessions generally, such as a session establishment requests or session modification requests. By using one or more approaches described herein, a device, such as a base station or WTRU, may achieve an efficient and secure of PDU session operations in a wireless communication network.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

What is claimed:

1. A method performed by a base station, the method comprising:
receiving a first request message from a wireless transmit receive unit (WTRU), wherein the first request message is a PDU session request message, wherein the request message includes a WTRU identifier (WTRU-ID);
selecting a session management entity based on receiving the first request message and one or more parameters, wherein the one or more parameters include: local configuration information, WTRU subscription information, network repository function information, WTRU capability information, or pooling information;
sending a second request message to the session management entity that has been selected, wherein the second request message includes at least part of the first request message;
receiving a first response message from the session management entity, wherein the first response message includes core network tunnel information, a PDU session establishment response message, and a security key; and
sending a second response message to the WTRU, wherein the second response message includes the PDU session establishment response and a PDU ID.

2. The method of claim 1, wherein the first request message further includes a Data Network name and slice identifier combination (DNN/S-NSSAI), prior PDU Session identifier (PDU-ID), an prior Key Set Identifier (KSI), or WTRU capability information.

3. The method of claim 2, wherein the at least part of the first request message includes at least one of the DNN/S-NSSAI, earlier PDU-ID, or earlier KSI.

4. The method of claim 1, wherein the second request message further includes a base station tunnel information.

5. The method of claim 4, wherein the base station tunnel information is an IP address for downlink traffic.

6. The method of claim 1, wherein one or more messages are received and sent with the WTRU to establish access stratum (AS) security prior to sending the second response message.

7. The method of claim 1, wherein one or more messages are received prior to receiving the first request message, wherein the one or more messages include local configuration information, subscription information, network repository function information, or pooling information.

8. The method of claim 1, wherein a broadcast message indicating that service-based interface capability information is sent to the WTRU before receiving the first request message.

9. The method of claim 1, wherein the PDU session request message is a session establishment request or a session modification request.

10. A base station, the base station comprising a processor operatively coupled to a transceiver, wherein:
the processor and transceiver are configured to receive a first request message from a wireless transmit receive unit (WTRU), wherein the first request message is a PDU session request message, wherein the request message includes a WTRU identifier (WTRU-ID);
the processor and transceiver are configured to select a session management entity based on receiving the first request message and one or more parameters, wherein the one or more parameters include: local configuration information, WTRU subscription information, network repository function information, WTRU capability information, or pooling information;
the processor and transceiver are configured to send a second request message to the session management entity that has been selected, wherein the second request message includes at least part of the first request message;
the processor and transceiver are configured to receive a first response message from the session management entity, wherein the first response message includes core network tunnel information, a PDU session establishment response message, and a security key; and
the processor and transceiver are configured to send a second response message to the WTRU, wherein the second response message includes the PDU session establishment response and a PDU ID.

11. The base station of claim 10, wherein the first request message further includes a Data Network name and slice identifier combination (DNN/S-NSSAI), prior PDU Session identifier (PDU-ID), an prior Key Set Identifier (KSI), or WTRU capability information.

12. The base station of claim 11, wherein the at least part of the first request message includes at least one of the DNN/S-NSSAI, earlier PDU-ID, or earlier KSI.

13. The base station of claim 10, wherein the second request message further includes a base station tunnel information.

14. The base station of claim 13, wherein the base station tunnel information is an IP address for downlink traffic.

15. The base station of claim 10, wherein one or more messages are received and sent with the WTRU to establish access stratum (AS) security prior to sending the second response message.

16. The base station of claim 10, wherein one or more messages are received prior to receiving the first request message, wherein the one or more messages include local configuration information, subscription information, network repository function information, or pooling information.

17. The base station of claim 10, wherein a broadcast message indicating that service-based interface capability information is sent to the WTRU before receiving the first request message.

18. The base station of claim 10, wherein the PDU session request message is a session establishment request or a session modification request.
